(19) United States
(12) Patent Application Publication
(10) Pub. No.: US 2022/0402037 A1
(43) Pub. Date: Dec. 22, 2022

(54) METHOD AND PLANT FOR THE RECOVERY OF PROCESSED POWDERED STRUCTURAL MATERIAL, AND RECOVERY DEVICE AND CARTRIDGE FOR A RECOVERY DEVICE OF THIS KIND

(71) Applicant: One Click Metal GmbH, Tamm (DE)

(72) Inventors: Till Blaser, Stuttgart (DE); Roman Denisov, Schwenningen (DE); Michael Volk, Freiburg (DE); Bjoern Ullmann, Boennigheim (DE); Stefan Weber, Besigheim (DE)

(21) Appl. No.: 17/777,024

(22) PCT Filed: Nov. 12, 2020
(86) PCT No.: PCT/EP2020/081955

§ 371 Date: May 14, 2022

(30) Foreign Application Priority Data
Nov. 15, 2019 (DE) 10 2019 130 951.4

(51) Int. Cl. B22F 10/73; B33Y 40/00; B33Y 30/00; B22F 12/80; B22F 12/00; B28B 1/00

(52) U.S. Cl. CPC B22F 10/73; B33Y 40/00; B33Y 30/00; B22F 12/80; B22F 12/38; B28B 1/001

(57) ABSTRACT

Method and plant for recovery of a processed, powdered structural material in a plant for manufacturing a three-dimensional component by selective solidification of the structural material by a beam directed onto the structural material, in which, in a construction station which includes a process chamber, the component is manufactured on a substrate plate in a construction module by layered hardening of the structural material and/or in which, in an unpacking station which includes an unpacking chamber, the component manufactured in the construction module is removed from the construction module, and the processed, non-hardened structural material is removed from the component, in which the processed structural material is collected in a collecting device by a recovery device and provided for further feeding into the process chamber for manufacturing further components, wherein the recovery device includes at least one cartridge filled with the processed structural material collected in the application device.

The invention relates to a method and a plant for the recovery of processed, powdered structural material, and to a recovery device and a cartridge for the recovery device.

DE 20 2013 009 787 U1 discloses a plant comprising a construction station for manufacturing workpieces by selective hardening by means of a beam acting on the structural material. Said plant further comprises a post-treatment station which comprises a plurality of successive stations, such as an exchange station, a parking station, a rotation station, and a removal station for the manufactured component. In the rotation station, a construction module, together with the manufactured three-dimensional component positioned therein, is transferred into an overhead arrangement. The non-hardened powdered structural material is fed to a powder recovery device via an outlet. Said device comprises a circuit line which transfers the powdered development material from the collecting tank into a sieving station, and from there feeds said material via a further circuit line to the construction station, wherein said circuit line leads into a powder inlet at the construction station.

A device and a method for generative manufacture of components by layered connection of powdered structural material on a substrate by means of an impinging laser beam is known from DE 10 2014 221 222 A1. The powder to be applied is provided in a cartridge, and the powder is applied onto the construction platform of a construction cylinder in a layered manner, from the cartridge, in order to manufacture the component.

Furthermore, a device for manufacturing a three-dimensional component by selective hardening by means of a beam acting on the powdered structural material is known from DE 10 2016 014 513 A1. Said device comprises a first and second receiving device for one cartridge in each case, which is provided for receiving storing and/or dispensing the powdered material. Said cartridges are arranged on an underside of a base in a process chamber. The powder can be transferred to the construction cylinder by means of a coating unit which can be moved along the base, in which cylinder the three-dimensional component is constructed by means of selective hardening of the powdered structural material.

A device for manufacturing three-dimensional components by selective hardening by means of a laser beam acting on the structural material is known from EP 2 921 286 A1. In the case of this device, it is provided for a cartridge to be positioned on a coating unit which is moved above a construction module for layered application of the structural material.

The object of the invention is that of proposing a method and a plant for the recovery of a processed powdered structural material, and a recovery device and a cartridge for a recovery device, which allows for a simplified circuit for recycling the processed, powdered structural material.

This object is achieved by a method for the recovery of a processed, powdered structural material, in that a collecting device of a recovery device is provided in a process chamber of a construction station and/or in an unpacking chamber of an unpacking station, wherein the recovery device comprises at least one cartridge which is filled with the processed, powdered structural material collected in the collecting device. The use of cartridges makes it possible for a simplified structure for an integrated circuit of a structural material to be made possible, in order to prepare the processed, powdered structural material and provided for a new manufacturing process of a three-dimensional component by selective hardening of the prepared powdered structural material by means of a beam acting on the structural material. Furthermore, such a cartridge system of the recovery device can make it possible for contact with the structural material to be minimised for the operating staff. Moreover, the recyclability of such cartridges of the recovery device allows for a cost-effective design, and meets ecological requirements.

According to a preferred embodiment of the method, the cartridge filled with the processed structural material is positioned in a sieving station, and the structural material provided by the at least one cartridge is supplied to a sieving device, and the processed structural material is freed of oversized particles and/or impurities by means of the sieving device. A transfer into a sieving station can thus take place, in a simple manner, after the processed structural material has been received in the cartridge. “Oversized particles” are understood to mean powdered structural material, the particle size of which is larger than the original particle size of the structural material. The oversized particles can result from baking or fusion of a plurality of powdered grains.

According to a further preferred embodiment of the method, in the sieving device the processed structural material is freed of oversized particles and/or impurities by means of ultrasound excitation acting on a sieve. This allows for simple and quick preparation of the processed structural material for a following work step.

It is furthermore preferably provided for at least one cartridge to be filled with the prepared powdered and processed structural material from the sieving device, and preferably for the oversized particles and/or the impurities to be discharged in at least one further cartridge. This firstly makes it possible that the cartridge, filled with processed and prepared structural material, can be supplied to a powder reservoir of the construction station for further use. In addition, the contaminated or no longer usable powdered structural material can be filled into the at least one cartridge and disposed of in a simple manner without contaminating the surroundings, wherein the cartridge can subsequently be used again for the recovery device.

The at least one cartridge comprising the prepared processed structural material is preferably positioned in a cartridge receptacle of a powder reservoir of the construction station. As a result, safe discharge of the powdered structural material, stored in the at least one cartridge, for subsequent manufacture of the three-dimensional component in the construction station can be performed via the powder reservoir.

Advantageously, the processed structural material is transferred, in the powder reservoir, from the at least one cartridge into a powder supply funnel, from which the powdered structural material is fed to the process chamber, preferably by means of a dosing device. Depending on the size of the powder reservoir, one or more cartridges may be positioned in a particular cartridge receptacle, in order to subsequently transfer a predetermined amount of processed structural material into the powder supply funnel such that a sufficient amount of processed structural material and/or fresh powdered structural material is provided for the subsequent process for manufacturing the three-dimensional component.

According to a further advantageous embodiment of the method, the processed structural material is fed to one collecting device in each case, both in the construction chamber and in the unpacking chamber, and the at least one cartridge is filled via the collecting device. As a result, both the structural material not hardened during the manufacture of the three-dimensional component, and the non-hardened structural material which is located in the construction chamber and is collected in the unpacking station, is again returned to the structural material circuit.

According to a further advantageous embodiment of the method, the at least one cartridge is filled using a dosing device in the collecting device. As a result, an overflow of the cartridge and contamination of the surroundings with the processed structural material can be prevented.

The object of the invention is furthermore achieved by a plant for recovery of a processed, powdered structural material, in which a recovery device comprises at least one collecting device for a processed powdered structural material which is provided for renewed supply of the processed structural material into a process chamber for manufacturing components, wherein the recovery device comprises at least one cartridge which can be arranged on at least one cartridge receptacle and with which processed structural material collected in the collecting device can be filled. Said at least one cartridge for receiving the processed powdered structural material allows for a flexible design for circulation of the structural material through the cartridge system. Furthermore, the use of cartridges of this kind allows for simple handling. A flexible structure or a flexible arrangement of the plant can also be made possible.

It is preferably provided for the process chamber of the construction station and/or the unpacking chamber of the unpacking station to each comprise a collecting device, and for the at least one cartridge to be able to be connected in at least one cartridge receptacle at every collecting device. This firstly allows for a higher degree of recovery of processed structural material for recycling. Furthermore, positioning the at least one cartridge in the at least one cartridge receptacle prevents contamination of the surroundings with the processed structural material upon transfer into the at least one cartridge.

Furthermore, a sieving station is preferably provided, in which the at least one cartridge can be fastened in at least one cartridge receptacle and dispenses the processed structural material to a sieving device. As a result, the sieving station can gradually prepare the amount of processed structural material fed via the cartridge, in a portion-wise manner.

It is preferably provided for a dosing device to be connected downstream of the at least one cartridge receptacle, in the sieving station, which dosing device dispenses the processed structural material, in a dosed manner, onto a following sieving device. As a result, a predefined amount of the processed structural material can be fed only to the sieving device, in order to free the processed structural material of oversized particles and/or impurities.

It is furthermore preferably provided for an outlet for oversized particles and/or impurities, and an outlet for prepared processed structural material, to be provided downstream of the sieving device, which outlets in each case comprise a cartridge receptacle in which at least one cartridge can be connected.

It is furthermore preferably provided for the construction station to comprise a powder reservoir having at least one cartridge receptacle in which at least one cartridge comprising prepared processed structural material and/or at least one cartridge comprising fresh structural material can be inserted. It is preferably possible for a plurality of cartridge receptacles to be provided in the powder reservoir, such that the sufficient amount of powdered structural material is stocked in the powder reservoir for a subsequent treatment process.

A dosing device is preferably connected downstream of the powder reservoir, by means of which dosing device the structural material can be fed from the at least one cartridge to the process chamber in the construction station. In this case, in particular the structural material is fed to a coating and/or levelling device, which dispenses a dosed layer of powdered structural material upon travelling once over a construction module. The structural material dispensed in excess can be removed from the process chamber by the coating and levelling device, and transferred into the collecting device.

It is furthermore preferably provided for the collecting device to comprise at least one dosing device for filling the at least one cartridge with processed structural material. This makes it possible for the collecting tank of the cartridge not to overflow during filling.

According to a further advantageous embodiment of the plant, the cartridge receptacle comprises a connection portion on which a locking device is provided, by means of which the cartridge, positioned on the connection portion, is detachably fixed. A locking device of this kind can be provided in the form of a snap-lock or click-lock system, or a bayonet closure, which allows for detachment and fixing of the cartridge in the cartridge receptacle in a simple manner.

It is furthermore preferably provided for a motor comprising an actuator to be provided on the cartridge receptacle, which actuator can be connected to a connection element of the cartridge for actuation of the closure flap upon insertion of the cartridge into the cartridge receptacle. As a result, after insertion of the cartridge into the cartridge receptacle, an actuation of the cartridge for opening the closure in the container may be provided by the machine control of the plant, in order to actuate the filling or emptying of the container with powdered structural material.

The cartridge advantageously comprises a container having an elongate opening for receiving the powdered structural material, wherein it is possible to actuate said elongate opening, with at least one closure element, for filling and emptying. As a result, the recyclability of such cartridges, as well as a cartridge circulatory system, is made possible.

It is advantageously provided for a closure flap to be provided which extends in a longitudinal central axis of the opening of the container of the cartridge and which comprises a connection element at one end face, and the closure element can preferably be transferred, by means of a rotational movement about the longitudinal axis thereof, into the open position and the closed position. This allows for simple actuation of the cartridge for opening and closing the container. Furthermore, opening and closing can be actuated.

The object of the invention is furthermore achieved by a recovery device for processed, powdered structural material, in which at least one cartridge is provided which can be positioned in a cartridge receptacle for filling and emptying fresh powdered structural material and/or processed powdered structural material. Said recovery device can be designed as a cartridge system or cartridge circulatory system, as a result of which simple handling is made possible. Furthermore, flexible adjustment to different plant designs is made possible.

According to a preferred embodiment of the cartridge of the recovery device, the cartridge is detachably fixed to a connection portion of the cartridge receptacle by means of a locking device, and a motor comprising an actuator is preferably provided on the cartridge receptacle, by means of which actuator it is possible to actuate a closure flap of the cartridge for opening and closing an opening of the container.

Advantageously, simple coupling of the control element on the motor to a connection element of the closure flap, upon insertion of the cartridge into the cartridge receptacle, is made possible. This can result in simplified handling, and, subsequently, simple actuation of the cartridge.

The object of the invention is furthermore achieved by a cartridge for a recovery device which comprises the features, described above, relating to the cartridge.

The invention and further advantageous embodiments and developments thereof are described and explained in greater detail in the following, with reference to the examples shown in the drawings. The features found in the description and in the drawings can be applied, according to the invention, individually or together, in any desired combination. In the drawings:

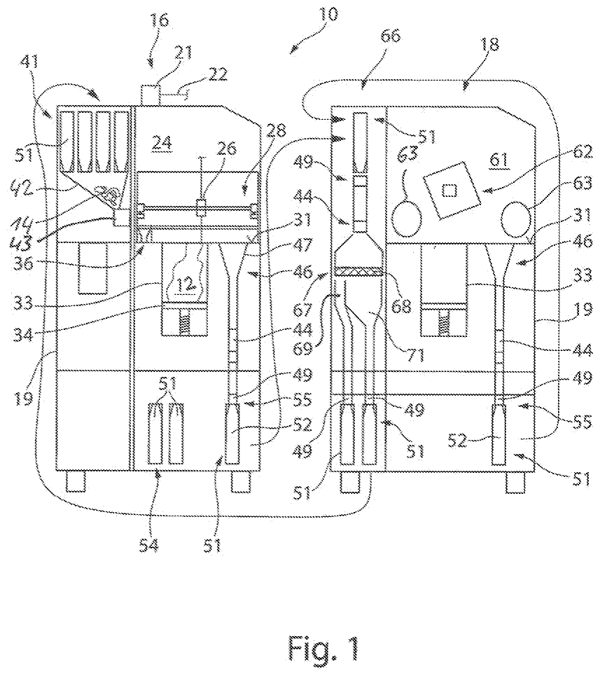

FIG. 1 is a schematic front view of a plant for recovery of processed, powdered structural material, comprising a construction station and an unpacking station,

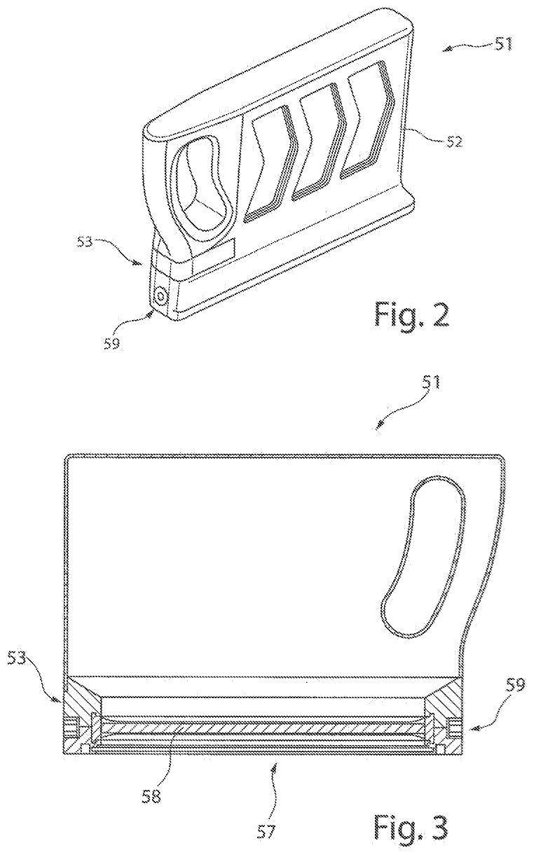

FIG. 2 is a perspective view of a cartridge of a recovery device,

FIG. 3 is a schematic cross section of the cartridge according to FIG. 2,

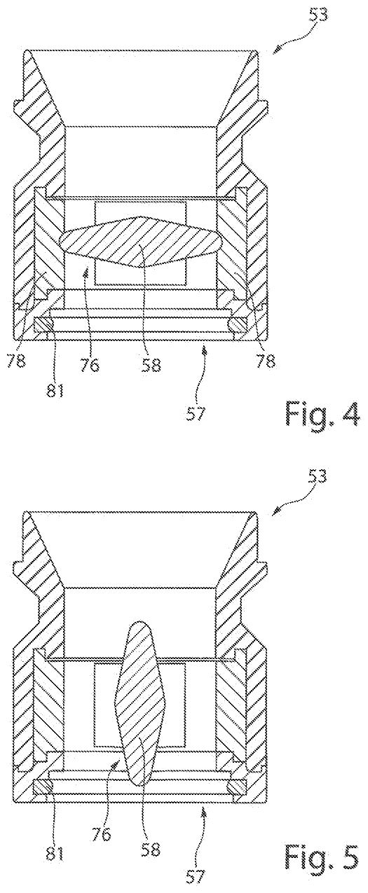

FIG. 4 is a schematic cross section of a closure flap of the cartridge according to FIG. 2, in a closed position,

FIG. 5 is a schematic cross section of a closure flap of the cartridge according to FIG. 2, in an open position,

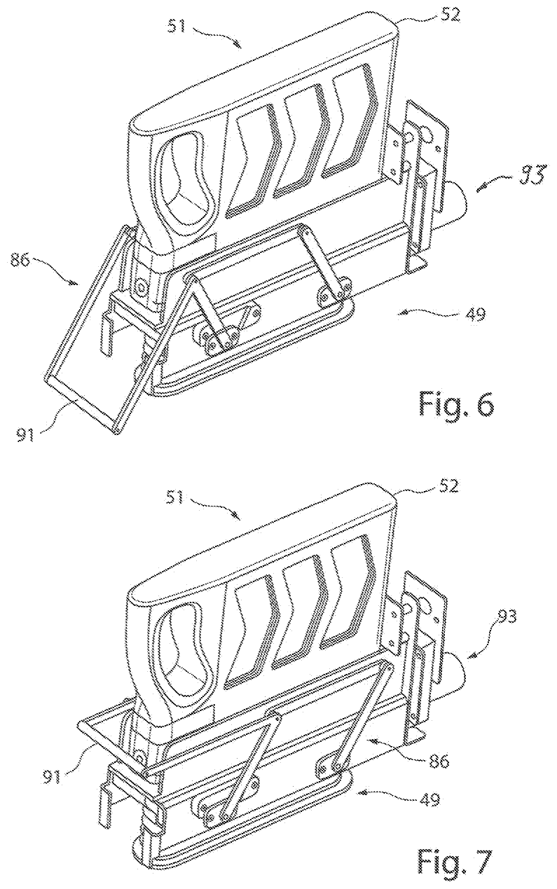

FIG. 6 is a perspective view of a cartridge in a cartridge receptacle comprising an unlocked locking device,

FIG. 7 is a perspective view of the cartridge according to FIG. 2, in the cartridge receptacle, comprising a locked locking device,

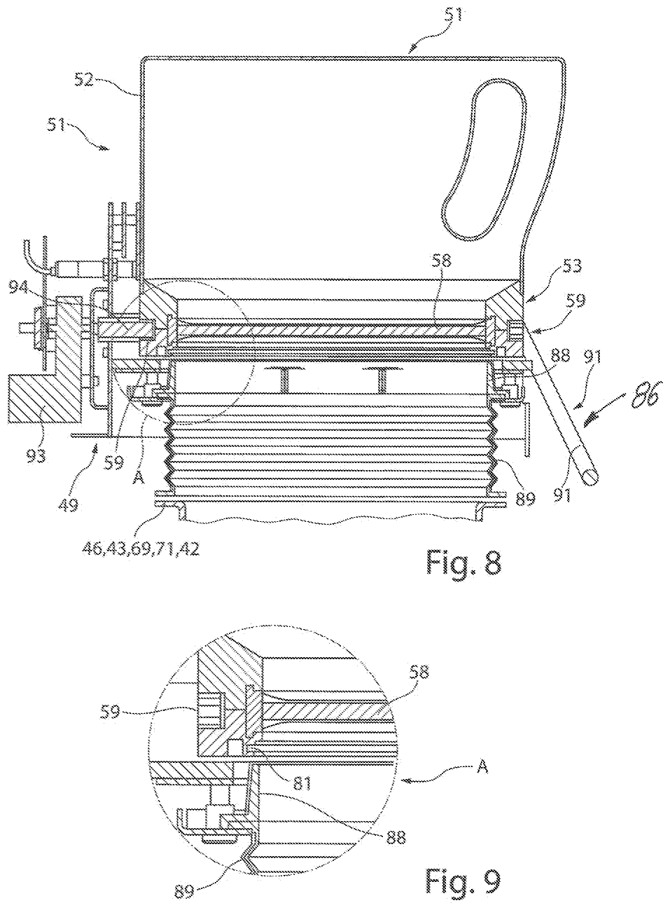

FIG. 8 is a schematic cross section of the cartridge and the cartridge receptacle according to FIG. 6, in an unlocked position,

FIG. 9 is a schematically enlarged view of Detail A in FIG. 8,

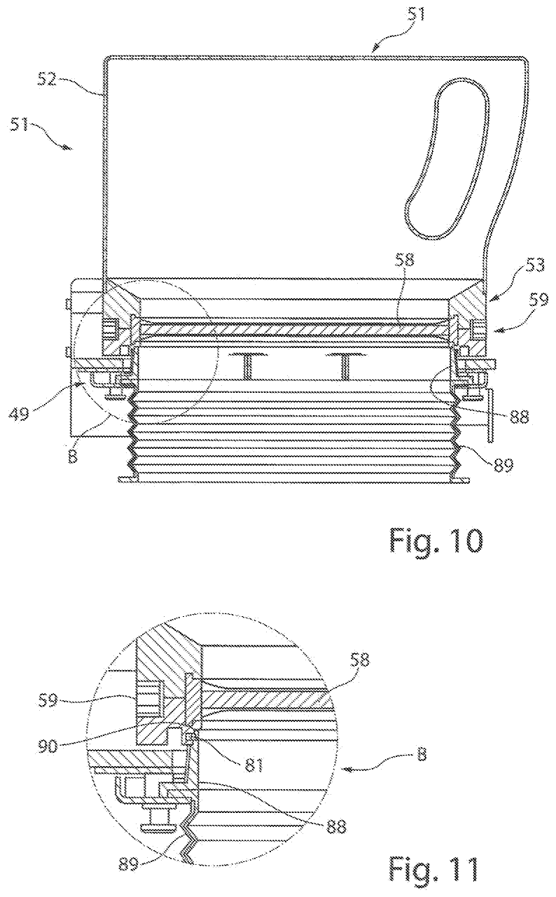

FIG. 10 is a schematic cross section of the cartridge and cartridge receptacle according to FIG. 7, in a locked position, and

FIG. 11 is a schematically enlarged view of Detail B in FIG. 10.

FIG. 1 is a schematic side view of a plant 10 for manufacturing a three-dimensional component 12 by means of successive hardening of layers of a powdered structural material 14. Said plant 10 comprises, for example, a construction station 16 and an unpacking station 18. Said construction station 16 and the unpacking station 18 each comprise a housing 19 and are provided separately from one another. Alternatively, said construction station 16 and the unpacking station 18 can also be provided in a common housing 19 of the plant 10.

The construction station 16 comprises a beam source 21, for example in the form of a laser source. Said beam source 21 emits a beam 22, in particular laser beam 22, which is fed to a processing head 26 in the process chamber 24 by means of beam guidance. The beam 22 is directed, via the processing head 26, to the structural material 14. Said processing head 26 is preferably arranged on a linear axis system 28. Said linear axis system 28 is preferably designed as a two-axis system, such that the processing head 26 can be moved, in the process chamber 24, in the x/y plane, in parallel with and above a work surface 31.

A construction module 33 is provided in the work surface 31, within which construction module a substrate plate 34 is guided so as to be movable back and forth. The three-dimensional component 12 is manufactured on said substrate plate 34, by selective hardening of the powdered structural material 14.

An application and levelling device 36 is preferably provided on the linear axis system 28. Said application and levelling device 36 travels over the work surface 31. In the process, the powdered structural material 14 can be applied in the construction module 33, and at the same time the structural material 14 applied in excess can be discharged from the construction module 33 into a collecting device 46, by means of the levelling device.

The structural material 14 preferably consists of a metal or ceramic powder. Other materials that are suitable and used for laser melting and/or laser sintering can also be used. The process chamber 24 is preferably hermetically sealed. In order to manufacture the three-dimensional component 12, said process chamber is filled with shielding gas or an inert gas, in order to prevent oxidation in the case of fusion of the structural material 14.

The construction station 16 furthermore comprises a powder reservoir 41. Said powder reservoir 41 comprises a powder supply funnel 42 which is preferably equipped with a filling level sensor, in order to record the stocked level of the structural material 14. By means of a dosing device 43, a predetermined amount of structural material 14 is removed from the powder supply funnel 42 and fed to the application and levelling device 36 in the process chamber 24.

The structural material 14 which is not hardened after the exposure process is transferred into a collecting device 46 by means of the application and levelling device 36. Said collecting device 46 preferably comprises a collecting funnel 47, the opening of which is integrated in the work surface 31 or is located in the work surface 31. Said collecting device 46 feeds the processed structural material 14, introduced via the application and levelling device 36, to a downstream dosing device 43.

A cartridge receptacle 49 is provided, in a manner associated with said collecting device 46, which cartridge receptacle is provided for connection of a cartridge 51. This cartridge 51 comprises a container 52 for receiving structural material 14. A predetermined amount of processed structural material is transferred into the cartridge 51 via the dosing device 43.

A storage location 54 for further cartridges 51 can be provided in the housing 19 of the construction station 16. Both filled and empty cartridges 51 can be stocked in this storage location 54.

The at least one cartridge receptacle 49 and the at least one cartridge 50 form a recovery device 55 for processed structural material 14.

Processed structural material 14 is understood to be a powdered structural material 14 of the kind that was fed to the process chamber 24 and not hardened by selective hardening by means of the beam 22. Said non-hardened powdered structural material 14 is conducted out of the process chamber 24 by the application and levelling device 36.

A fresh powdered structural material 14 is understood to mean a structural material 14 which was provided for the first time for the manufacture of a three-dimensional component 12, and is fed to the process chamber 24 for the process for manufacturing the three-dimensional component 12.

In the case of the construction station 16, it is preferably provided for the powder reservoir 41 to comprise at least one cartridge receptacle 49, preferably four cartridge receptacles 49, into which in each case cartridges 51 for dispensing powdered structural material 14 can be inserted.

The unpacking station 18 comprises an unpacking chamber 61, into which the construction module 33, which is preferably closed with a lid for removal from the process chamber 24, can be inserted, in order to subsequently empty it in the unpacking station 18. The substrate plate 34 together with the component 12 is removed from the construction module 33 and cleaned of non-hardened structural material 14, for example by means of a rotary/pivot assembly 62 in the unpacking chamber 61. The processed structural material 14 collecting in the unpacking chamber 61, on a work surface 31, is transferred into a collecting device 46, which is designed in a manner analogous to the collecting device 46 of the construction station 16. Processed structural material 14 is fed to the cartridge 51 via the dosing device 43. Said cartridge 51 is provided in the at least one cartridge receptacle 49.

Openings 63 having glove operation can be provided in the unpacking chamber 61, in order to free the component 12 of loose structural material 14 and feed said material to the collecting device 46. A suction device can also be provided for cleaning the component 12 and/or the work surface 31.

The cartridge 51 filled with the processed structural material 14 is fed to a sieving station 66. Said sieving station 66 may be integrated in the unpacking station 18. The sieving station 66 may also be integrated in the construction station 16. The sieving station 66 may also be arranged in an isolated manner, and separately from the construction station 16 and unpacking station 18. The construction station 16, the unpacking station 18 and the sieving station 66 can also form a common plant in a housing 19.

The sieving station 66 comprises at least one cartridge receptacle 49 for receiving the at least one cartridge 51. The processed structural material 14 dispensed by the at least one cartridge 51 is preferably fed, by means of a dosing device 43, in particular a dosing screw, to a sieving device 67. Said sieving device 67 comprises a sieve 68 which is preferably excited by means of ultrasonic vibrations. As a result, the processed, powdered structural material 14 can be cleaned. For example, coarse particles or oversized particles and/or impurities can be held back by the sieve 68 and transferred into an outlet opening 69. Said outlet opening 69 is connected to a cartridge receptacle 49, in which the at least one cartridge 51 can be arranged. The processed, powdered structural material 14, which is free of oversized particles and/or impurities, is discharged via a further outlet opening 71. Said further outlet opening 71 opens into at least one cartridge receptacle 49, in which at least one cartridge 51 for receiving the processed and cleaned powdered structural material 14 is provided.

Subsequently, the at least one cartridge 51 comprising the prepared processed structural material 14 is fed to the powder reservoir 41 and fixed in at least one cartridge receptacle 49 for dispensing the structural material 14.

FIG. 2 is a perspective view of the cartridge 51, and FIG. 3 is a schematic cross section of the cartridge 51 according to FIG. 2.

Said cartridge 51 comprises a container 52 for receiving the powdered structural material 14. The cartridge 51 furthermore comprises a cartridge closure 53. An opening 57 is provided in the cartridge closure 53, which is provided as an elongate opening. A closure flap 58, which extends along the longitudinal central axis of the opening 57, can be transferred, by a connection element 59, into a closed position 76 and into an open position 77 (FIGS. 4 and 5).

FIG. 4 is a further schematic cross section of the closure flap 58 for the cartridge 51 in the closed position 76. FIG. 5 is a schematic cross section of the cartridge closure 53 with the closure flap 58 in an open position 77. Said closure flap 58 may be made of metal, aluminium, or plastics material. In the closed position 76, the closure flap 58 engages on laterally arranged sealing elements 78. Sealing elements 78 of this kind can consist of a rubbery-elastic material, in particular TPE or a silicone or the like.

A further seal 81 is preferably provided on an end face of the opening 57 of the cartridge closure 53, which further seal is provided for sealing contact on the cartridge receptacle 49 following positioning of the cartridge 51 on the cartridge receptacle 49.

FIG. 6 is a perspective view of the cartridge 51 in a position fitted onto the cartridge receptacle 49, having a locking device 86 in an unlocked position. FIG. 7 shows the locking device 86 in a locked position.

FIG. 8 is a schematic cross section of the arrangement according to FIG. 6. FIG. 9 is a schematically enlarged view of Detail A in FIG. 8. FIG. 10 is a schematic cross section of the arrangement according to FIG. 7. FIG. 11 is a schematically enlarged view of Detail B in FIG. 10.

The cartridge receptacle 49 comprises a connection portion 88, the shape of which corresponds to the opening 57 of the cartridge closure 53. The connection portion 88 is preferably provided on a bellows 89 or a resiliently yielding connection element. Said bellows 89 or the resilient connection element engages on the application device 46, the dosing device 43, the outlet openings 69 71, and the powder supply funnel 42, or the like, opposite the connection portion 88.

Furthermore, a motor 93 comprising a control element 94 is provided on the cartridge receptacle 49. When the cartridge 51 is fitted into the cartridge receptacle 49, the control element 94 engages on the connection element 59, in order to open and close the closure flap 58.

The locking device 86 comprises an actuation lever 91 which is connected to a locking mechanism and which engages on the cartridge closure 53 and fixes the cartridge closure 53 to the connection portion 88 in a defined position. This is shown in Detail B in FIG. 11.

The connection portion 88 is pulled into the opening 57 of the cartridge closure 53 by means of the locking mechanism of the locking device 86. In the process, the connection portion 88, which is designed so as to be conically tapering on the outside thereof, engages in the opening 57, and rests on a shoulder 90 of the opening 57. This provides a defined arrangement and positioning of the connection portion 88 in the opening 57, such that no structural material can escape when filling and emptying the container 52 of the cartridge 51.

In the following, the cartridge circulatory system of the recovery device 55 is described in greater detail, with reference to FIG. 1.

The structural material 14 introduced into the process chamber 24, which material was not hardened by the laser beam, is fed to the collecting device 46. The processed structural material 14 enters the cartridge 51 via the dosing device 43. Said cartridge 51 is transferred into the sieving device 67. The structural material 14 located in the cartridge 51 can be fed to the sieving station 66 via a dosing device 43. The structural material 14, freed of oversized particles and/or impurities, is in turn collected in a cartridge 51, which is used for recycling the processed structural material 14 into the cartridge receptacle 49 of the powder reservoir 41. An analogue procedure is provided for the non-hardened and processed structural material 14 in the unpacking station 18. The processed structural material 14 is transferred out of the unpacking chamber 61 and into the collecting device 46, and received by a cartridge 51. This is in turn fed to the sieving device 67, in order to clean the processed structural material 14. The structural material 14 cleaned by the sieving device 67 is received by a cartridge 51 and subsequently fed to the cartridge receptacle 49 in the powder reservoir 41 of the construction station 16 to be fed further into the process chamber 24.

1. Method for recovery of a processed, powdered structural material in a plant for manufacturing a three-dimensional component by selective hardening of the structural material by means of a beam directed onto the structural material,
in which, in a construction station which comprises a process chamber, the component is manufactured on a substrate plate in a construction module by means of layered hardening of the structural material, and/or
in which, in an unpacking station which comprises an unpacking chamber, the component manufactured in the construction module is removed from the construction module, and the processed, non-hardened structural material is removed from the component,
in which, by means of a recovery device, the processed structural material is collected in a collecting device and provided for further feeding into the process chamber for manufacturing further components,
wherein
the recovery device comprises at least one cartridge which is filled with the processed structural material collected in the application device.

2. Method according to claim 1, wherein the cartridge filled with processed structural material is positioned in a sieving station, and in that the processed structural material provided by the at least one cartridge is supplied to a sieving device and the processed structural material is freed of oversized particles and/or impurities by means of the sieving device.

3. Method according to claim 2, wherein, in the sieving device, the processed structural material is freed of oversized particles and/or impurities by means of ultrasound excitation acting on a sieve.

4. Method according to claim 2, wherein the at least one cartridge is filled with prepared, processed structural material in the sieving station, and scrap material is received in at least one further cartridge.

5. Method according to claim 4, wherein the at least one cartridge comprising prepared, processed structural material is positioned in a cartridge receptacle of a powder reservoir of the construction station and/or a powder supply funnel in the powder reservoir is filled with the processed structural material from the at least one cartridge, and/or the at least one cartridge is filled using a dosing device in the collecting device.

6. (canceled)

7. Method according to claim 1, wherein the processed structural material in the construction station and in the unpacking station is fed to one collecting device in each case, and the at least one cartridge associated with the relevant collecting device is filled which are transferred into the sieving station after filling.

8. (canceled)

9. Plant for recovery of a processed, powdered structural material for manufacturing a three-dimensional component by selective hardening by means of a beam acting on the structural material,
comprising a construction station which comprises a process chamber, in which the component is manufacturable on a substrate plate in a construction module, in a layered manner, by means of hardening of the structural material, and/or
comprising an unpacking station which comprises an unpacking chamber, in which the component is removable from the construction module, and processed structural material detaches from the component,
wherein
a recovery device is provided, which comprises at least one cartridge which is arrangable on at least one cartridge receptacle and with which the processed structural material collected in the collecting device is fillable.

10. Plant according to claim 9, wherein the process chamber and the unpacking chamber each comprise a collecting device, and the at least one cartridge can be connected in at least one cartridge receptacle at every collecting device.

11. Plant according to claim 9, wherein the collecting device comprises at least one dosing device for filling the at least one cartridge with processed structural material.

12. Plant according to claim 9, wherein a sieving station is provided, in which the at least one cartridge can be fastened in the at least one cartridge receptacle and dispenses the processed structural material to a sieving device.

13. Plant according to claim 12, wherein a dosing device is provided between the at least one cartridge receptacle in the sieving station and the sieving device.

14. Plant according to claim 9, wherein the sieving device comprises an outlet opening for oversized particles and/or impurities, and an outlet opening for processed structural material which is free of oversized particles and/or impurities.

15. Plant according to claim 9, wherein the at least one cartridge comprising prepared processed structural material or comprising fresh structural material is insertable into at least one cartridge receptacle of a powder reservoir, and the structural material is preferably feedable from the at least one cartridge to the process chamber via a dosing device.

16. Plant according to claim 9, wherein the at least one cartridge receptacle comprises a connection portion on which a locking device is provided, by means of which the cartridge positioned on the connection portion is fixable.

17. Plant according to claim 9, wherein a motor comprising a control element is provided on the at least one cartridge receptacle, which control element is connectable to the connection element of a cartridge closure of the at least one cartridge upon insertion of the cartridge into the cartridge receptacle.

18. Plant according to claim 9, wherein the at least one cartridge comprises a container having an elongate opening in the container closure.

19. Plant according to claim 18, wherein a closure element is provided which extends in the longitudinal central axis of the opening of the cartridge closure and which comprises, at the end face, the connection element by means of which the closure flap is actuable for opening and closing.

20. Recovery device for processed, powdered structural material which is hardened in a plant for manufacturing a three-dimensional component by selective hardening by means of a beam acting on the structural material, wherein at least one cartridge is provided which can be positioned in at least one cartridge receptacle for filling and emptying fresh, powdered structural material or processed, powdered structural material.

21. Recovery device according to claim 20, wherein the at least one cartridge is detachably fixed to a connection portion of the at least one cartridge receptacle by means of a locking device, and a motor comprising a control element is preferably provided on the at least one cartridge receptacle, by means of which control element a closure flap of the cartridge closure can be actuated for opening and closing the container.

22. Cartridge for a recovery device for a processed, powdered structural material, wherein the cartridge has the features according to claim 9 which relate to the cartridge.
